(19) United States
(12) Patent Application Publication
(10) Pub. No.: US 2012/0166415 A1
(43) Pub. Date: Jun. 28, 2012

(54) SUPPLEMENTING SEARCH RESULTS WITH KEYWORDS DERIVED THEREFROM

(75) Inventors: James Henry Lewallen, Fall City, WA (US); Cezary Marcjan, Redmond, WA (US); Matthew Bret MacLaurin, Woodinville, WA (US); Todd Daniel Newman, Mercer Island, WA (US); David Shigeru Taniguchi, Kirkland, WA (US)

(73) Assignee: MICROSOFT CORPORATION, Redmond, WA (US)

(21) Appl. No.: 12/977,100

(22) Filed: Dec. 23, 2010

(51) Int. Cl. G06F 17/30

(52) U.S. Cl. 707/711; 707/E17.108

(57) ABSTRACT

Embodiments are provided for creating a personalized search index and supplementing searches with an additional set of keywords. A first set of keywords is received from a user. A first index associated with the user is searched using the first set of keywords to generate a first set of search results. The first index includes content identified by the user. A second set of keywords is defined based on the first set of search results. A second index is searched using the second set of keywords to generate a second set of search results. At least a portion of the first and second sets of search results is provided to the user. Some embodiments are implemented as a cloud computing service.

### BACKGROUND

Various searching technologies exist. Some existing systems search multiple databases to provide search results to a user. Other systems attempt to personalize the search results by filtering the search results based on geographic region, content type, or language. In such systems, however, the same set of search terms provided by the user is used to perform the searching. Additionally, the existing systems fail to consider the interests of the user beyond the input keywords when performing the searches.

### SUMMARY

Embodiments of the disclosure provide context for search results. A first set of keywords is received from a user. A computing device searches a first index based on the received first set of keywords to generate a first set of search results. The first index is associated with the user and includes documents identified by the user. A second set of keywords is defined based on the generated first set of search results. A computing device searches a second index based on the defined second set of keywords to generate a second set of search results. The second index is associated with at least one other user. At least a portion of the first set of search results and at least a portion of the second set of search results are provided to the user.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating users interacting with one or more computing devices to supplement search results with additional search results representing contextual information.

FIG. 2 is an exemplary flow chart illustrating operation of a computing device to register a user and create an index for the user based on user-identified content.

FIG. 3 is an exemplary flow chart illustrating operation of a computing device to obtain and provide search results supplemented by contextual information.

FIG. 4 is an exemplary user interface illustrating a browser displaying search results supplemented by additional search results providing context.

Corresponding reference characters indicate corresponding parts throughout the drawings.

### DETAILED DESCRIPTION

Referring to the figures, embodiments of the disclosure provide a personalized search index. The personalized search index is created from content 114 identified by a user 102 and may be accessed by the user 102, in some embodiments, via a web-hosted search engine. Aspects of the disclosure perform search queries on the personalized search index based on a first set of keywords to generate a first set of search results, and perform another search query on at least one other index based on a second set of keywords derived from the first set of search results. The resulting second set of search results supplements, provides context to, explains, or otherwise enhances the first set of search results. For example, aspects of the disclosure identify articles or documents as context for each item in the first set of search results.

In some embodiments, the elements of the disclosure are cloud-hosted and performed by a cloud computing service. In such embodiments, the user 102 is able to access the search functionality using any user computing device and obtain the same results from any user computing device.

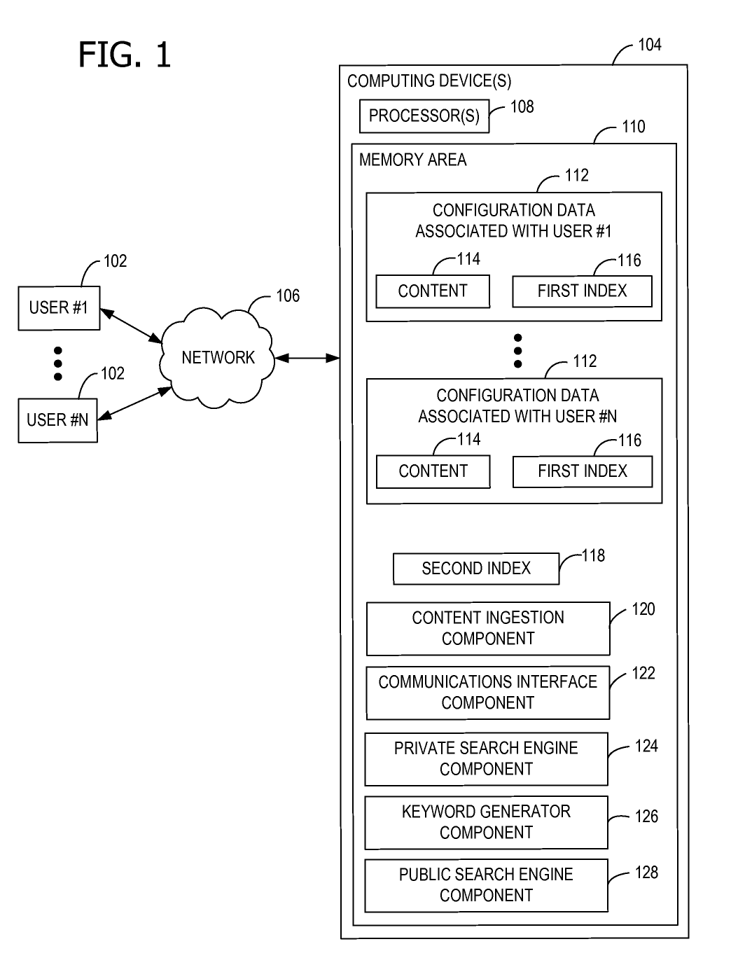

Referring again to FIG. 1, an exemplary block diagram illustrates users 102 interacting with one or more computing devices 104 to supplement search results with additional search results representing, for example, contextual information. The users 102, such as user #1 through user #N, communicate with the computing device 104 via a network 106 such as the Internet. Embodiments contemplate, however, other networks and configurations including wired and/or wireless networks. The network 106 supports, for example, local area networks, peer-to-peer communication, and client-server communication.

The computing device 104 represents any device executing instructions (e.g., as application programs, operating system functionality, or both) to implement the operations and functionality for providing context for search results as described herein. The computing device 104 may include one or more servers, desktop computers, laptops, netbooks, gaming devices, kiosks, tabletop devices, and/or portable media players. Additionally, the computing device 104 may represent a group of processing units or other computing devices. In some embodiments, the computing device 104 is part of a cloud computing service having a plurality of computing devices such as computing device 104.

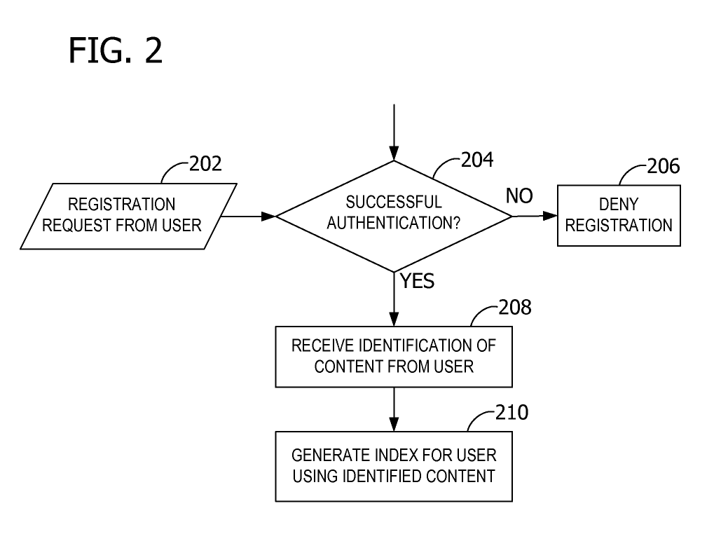

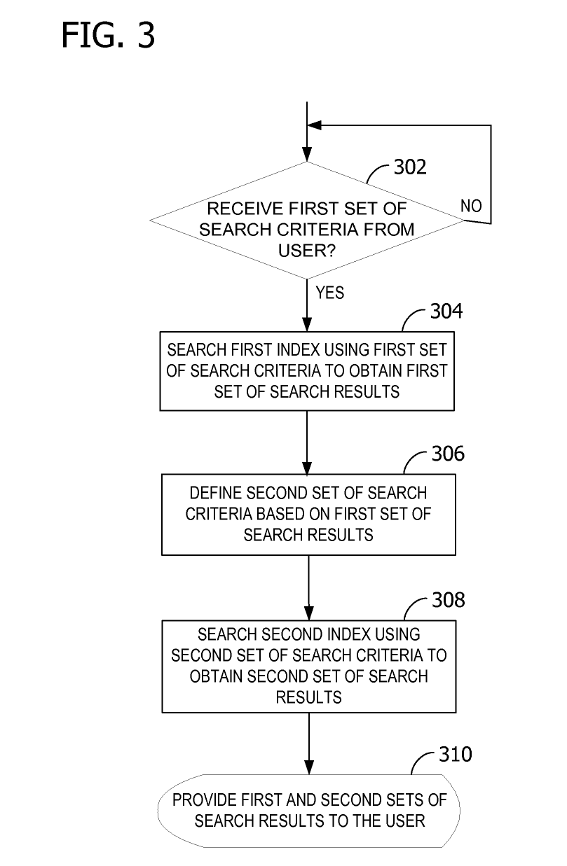

The computing device 104 has at least one processor 108 and a memory area 110. The processor 108 includes any quantity of processing units, and is programmed to execute computer-executable instructions for implementing aspects of the disclosure. The instructions may be performed by the processor 108 or by multiple processors executing within the computing device 104, or performed by a processor external to the computing device 104. In some embodiments, the processor 108 is programmed to execute instructions such as those illustrated in the figures (e.g., FIG. 2 and FIG. 3).

The computing device 104 further has one or more computer-readable media such as the memory area 110. The memory area 110 includes any quantity of media associated with or accessible by the computing device 104. The memory area 110 may be internal to the computing device 104 (as shown in FIG. 1), external to the computing device 104 (not shown), or both (not shown).

The memory area 110 stores, among other data, configuration data 112 for each of the registered users 102, such as configuration data 112 associated with user #1 through configuration data 112 associated with user #N. The configuration data 112 includes content 114 and a first index 116 for each of the users 102. Each combination of the content 114 and the first index 116 are specific, particular to, or otherwise associated with at least one of the users 102. The content 114 may include a copy of the actual content, pointers or references or links to the content, and/or data describing the content. For example, the content 114 includes one or more of the following: a social networking feed, a content feed, contact data, an electronic mail message, a text message, a web page, user browsing history, and user interaction data. The content 114 may include user-authored content and content authored by other entities. The content 114 is used to define the first index 116 and corresponds thereto.

The memory area 110 further stores a second index 118 as described below. The second index 118 may be generated from content from the general public, and is not specific or limited to any one or more of the users 102. Additional description of the second index 118 is provided below.

The memory area 110 further stores one or more computer-executable components. Exemplary components include a content ingestion component 120, a communications interface component 122, a private search engine component 124, a keyword generator component 126, and a public search engine component 128. Operation of the components is described below with reference to FIG. 2 and FIG. 3.

Referring next to FIG. 2, an exemplary flow chart illustrates registration of the user 102 and creation of an index for the user 102 based on user-identified content 114. The operations illustrated in FIG. 2 are performed by the computing device 104 in some embodiments. For example, the computing device 104 may be associated with a cloud computing service.

At 202, a registration request from the user 102 is received by the computing device 104. The registration request includes, for example, authentication information or other information identifying the user 102. If the computing device 104 is able to successfully authenticate the user 102 at 204, the computing device 104 proceeds to create or update the index associated with that user 102. If the computing device 104 is unable to successfully authentication the user 102 at 204, the registration request is denied at 206.

At 208, the computing device 104 receives identification of one or more items of content 114 from the user 102. The identification of the content 114 may be included, in some embodiments, in the registration request. For example, the content 114 includes one or more of the following: a document, an article, a text selection, digital media content, a social networking stream, a content feed, contact data, an electronic mail message, a text message, a web page, user browsing history, and user interaction data (e.g., data describing the user interaction with a user computing device such as applications executing, time spent on each application, etc.).

At 210, the computing device 104 generates an index (e.g., the first index 116) for the user 102 based on the user-identified content 114. For example, the content 114 stored in the memory area 110 (or referenced by a pointer or link stored in the memory area 110), is scanned, parsed, interpreted, or otherwise analyzed to derive data for inclusion in the first index 116. In such an example, the first index 116 is generated based on, at least in part, the derived data. As such, the first index 116 represents a private index specific or particular to the user 102, and may be protected by authentication as shown in FIG. 2. The first index 116 is stored, in some embodiments, in the memory area 110 shown in FIG. 1.

Alternatively or in addition, the first index 116 may be generated based in part on content or other data not specifically identified by the user 102. In some embodiments, data describing the user 102 is obtained by a user computing device and provided to the computing device 104 for use in generating the first index 116. For example, the user computing device monitors the user's behavior (e.g., tracks web page navigation or document processing) on the user computing device and provides data describing the user's behavior to the computing device 104 (e.g., identifies the web pages visited by the user 102 or the documents viewed or created by the user 102).

In some embodiments, the content ingestion component 120 from FIG. 1, when executed by the processor 108, causes the processor 108 to generate the first index 116 for one of the users 102 from data associated with the user 102. For example, the content ingestion component 120 may perform one or more of the operations illustrated in FIG. 2, such as operation 210.

The operations illustrated in FIG. 2 may be performed at registration or after registration. For example, the user 102 may return to add more content 114 to the first index 116, or the first index 116 may be continually updated as the user computing device collects content 114 for inclusion in the first index 116 (e.g., based on continually updating data streams such as content feeds).

While aspects of the disclosure are described with reference to one or more indexes, embodiments of the disclosure are operable on any collection of data including files, databases, binary large objects, and the like. The collection of data may or may not be organized to facilitate performance of search queries by a search engine.

Referring next to FIG. 3, an exemplary flow chart illustrates operation of the computing device 104 to obtain and provide search results supplemented by contextual information. The operations illustrated in FIG. 3 are performed by the computing device 104 in some embodiments. For example, the computing device 104 may be associated with a cloud computing service.

At 302, if a first set of search criteria (e.g., one or more search criteria) is received by the computing device 104 from the user 102, the first index 116 is searched. The first set of search criteria may include, in some embodiments, keywords and/or time-ranges (e.g., entries created since the last time the user 102 performed a search). For example, the communications interface component 122 in FIG. 1, when executed by the processor 108, causes the processor 108 to receive a first set of keywords from the user 102. The communications interface component 122 may include a network interface card and/or computer-executable instructions (e.g., a driver) for operating the network interface card. As used herein, a “set” includes at least one element. For example, the set may include one element.

Exemplary search criteria include keywords such as words, partial words, entities, terms, phrases, symbols, images, and/or any other input given by the user 102 instructing the computing device 104 to perform a search based thereon. In some embodiments, the user 102 enters the search criteria into the user computing device such as a laptop, desktop, tablet, gaming console, or mobile telephone. For example, the user 102 enters the search criteria into an application such as a browser or search engine application executing on the user computing device. In some embodiments, the user 102 may exchange data with the user computing device via one or more of the following ways: keyboard, touch screen, camera, microphone, and one or more accelerometers. For example, the user 102 may input commands or manipulate data by moving the user computing device in a particular way. The user computing device then transmits the search criteria to the computing device 104.

Alternatively or in addition, the first set of search criteria includes search criteria generated or derived by the computing device 104 or by the user computing device without being input specifically by the user 102 for performing a search. For example, the search criteria may be derived from a monitoring and/or analysis of user activity, browsing history, a document, or any other content or user behavior. For example, the user computing device collects the data describing the user 102 and provides the collected data to the computing device 104. In this manner, aspects of the disclosure operate in the background to obtain relevant search results ready to present to the user 102 when the user 102 wishes to see search results.

At 304, the first index 116 is searched based on the received first set of search criteria to generate a first set of search results. The searching may be performed by any search algorithm that operates to search data represented in any form.

In some embodiments, the private search engine component 124 in FIG. 1, when executed by the processor 108, causes the processor 108 to search, based on the first set of keywords received by the communications interface component 122, the first index 116 generated by the content ingestion component 120 to produce the first set of search results.

At 306, a second set of search criteria is defined based on the first set of search results. For example, the computing device 104 scans, parses, or otherwise analyzes each item in the first set of search results. Search criteria are identified based on the analysis, and one or more of the identified search criteria are included in the second set of search criteria. The second set of search criteria represents topics or concepts presents in the first set of search results. For example, the computing device 104 may perform a trending analysis on the items in the first set of search results. The second set of search criteria may be defined based in part on data derived from the trending analysis. Exemplary search criteria include keywords such as words, partial words, entities, terms, phrases, symbols, images, and/or the like enabling the computing device 104 to perform a search based thereon.

In some embodiments, there is a one-to-one correspondence between each search criterion in the second set of search criteria and each item in the first set of search results. In other embodiments, each item in the first set of search results is associated with a plurality of the search criteria in the second set of search criteria.

Alternatively or in addition, the second set of search criteria may be generated at least partly based on user behavior or interaction with the first set of search results as monitored by the user computing device. For example, only the items in the first set of search results that the user 102 selects or activates are parsed to define search criteria for inclusion in the second set of search criteria. In this manner, a highly focused set of search criteria may be defined to generate relevant additional information while minimizing expenditure of search resources.

In some embodiments, the first set of search results may be filtered before defining the second set of search criteria. For example, the second set of search criteria may be defined based in part on a date associated with each of the items in the first set of search results. In such embodiments, a subset of the first set of search results may be selected based on date (e.g., select the items with the most recent dates). The second set of search criteria may be generated from the selected subset of the first set of search results.

In the example of FIG. 1, the keyword generator component 126, when executed by the processor 108, causes the processor 108 to define a second set of keywords based on the first set of search results generated by the private search engine component 124.

At 308, the computing device 104 searches the second index 118 based on the second set of search criteria to generate a second set of search results. In some embodiments, the second index 118 represents a public index or other data collected from at least one other user (e.g., another user from users 102). For example, the second index 118 is created from a web crawler that processes publicly available content on the Internet. The second set of search results represents contextual information or other data describing, explaining, or otherwise supplementing the first set of search results.

In some embodiments, the public search engine component 128 in FIG. 1, when executed by the processor 108, causes the processor 108 to search the second index 118 based on the second set of keywords defined by the keyword generator component 126 to generate the second set of search results.

At 310, the first set of search results and the second set of search results are provided for display to the user 102 (e.g., via the communications interface component 122 in FIG. 1). For example, the computing device 104 transmits the first set of search results and the second set of search results to the user computing device. The user computing device then displays at least a portion of the first set of search results and at least a portion of the second set of search results to the user 102. If the computing device 104 and the user computing device are the same device, providing the first set of search results and the second set of search results includes the actual display of the sets of search results to the user 102.

Aspects of the disclosure contemplate many ways for the first set of search results and the second set of search results to be provided and/or displayed to the user 102. The first set of search results and the second set of search results may be provided and/or displayed according to any organization, grouping, configuration, order, or the like. In an example, at least a portion of the first set of search results is provided to the user 102 before or during the search of the second index 118. In another example, the first set of search results and the second set of search results are combined or merged together for collective display to the user 102. In another example, the second set of search results is displayed to the user 102 only after receiving a request from the user 102. For example, the user 102 may click, hover, gesture, or otherwise select or activate one of the search results in the first set of search results. In response, the second set of search results is provided to the user 102. For example, only the portion of the second set of search results corresponding to the selected portion of the first set of search results may be provided. Alternatively, a plurality of items from the second set of search results may be provided and/or displayed to the user 102 in response to the request. In such embodiments, the portion of the second set of search results corresponding to the selected portion of the first set of search results may be highlighted, underlined, or otherwise visually distinguished to the user 102. In still another example, the second set of search results is displayed to the user 102 after a brief delay from the display of the first set of search results.

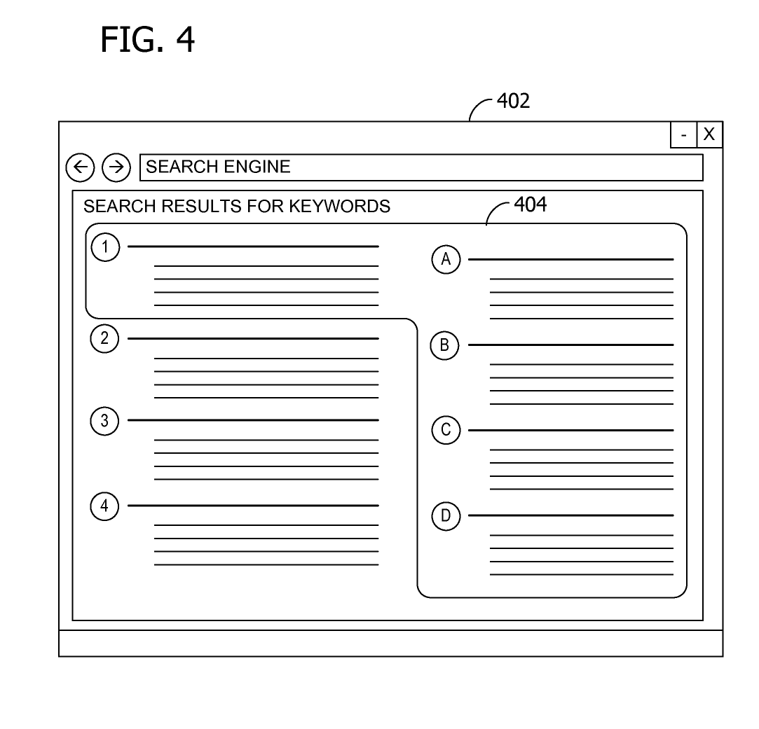

Referring next to FIG. 4, an exemplary user interface 402 illustrates a browser displaying search results supplemented by additional search results to provide context. On the left side of the browser in FIG. 4, items #1, #2, #3, and #4 are part of the first set of search results. The user 102 has selected item #1 from the first set of search results, which has resulted in the display of items A, B, C, and D from the second set of search results. The items A, B, C, and D are visually linked via polygon 404 to item #1 to show the relationship or correspondence therebetween.

If the user 102 were to select item #2, #3, or #4 from the first set of search results on the left side of the browser, the items A, B, C, and D would update to show the portions of the second set of search results that correspondence to the selected item from the first set of search results. Similarly, the polygon 404 would then encompass item #2 and items A, B, C, and D.

In some embodiments, the first set of search results is a collection of microblog messages. In a specific example, one of the microblog messages includes a link to a news article with the following title: “New Budget Director Explains Drastic Pay Freeze for Most Civilians.” Aspects of the disclosure generate the second set of keywords to include the words “Budget,” “Director,” “Pay,” “Freeze,” and “Civilians.” The second set of search results then includes context on the budget director and other articles on the pay freeze. This provides the user 102 with different perspectives on the news article.

In another example, the first set of search results includes an obituary for a famous movie star. Aspects of the disclosure identify search criteria within the first set of search results to generate the second set of search criteria to identify other articles relating to the movie star.

### Additional Examples

In some embodiments, the private search engine component 124 and the public search engine component 128 represent the same search engine configured to perform queries on different indexes (e.g., the first index 116 versus the second index 118).

In an example scenario, the user 102 is able to perform an analysis on the indexed content 114 to identify time-based trends, identify entities, or obtain other metrics from the user-identified content 114 in the first index 116.

In another example, the computing device 104 provides an application programming interface (API) allowing the user 102 to interact with embodiments of the disclosure (e.g., register, provide keywords, receive search results, etc.).

In still another example, the user 102 has associated therewith a plurality of first indexes, and is able to specify which of the first indexes should be searched when providing the first set of search criteria.

At least a portion of the functionality of the various elements in FIG. 1 may be performed by other elements in FIG. 1, or an entity (e.g., processor, web service, server, application program, computing device, etc.) not shown in FIG. 1.

In some embodiments, the operations illustrated in FIG. 2 or FIG. 3 may be implemented as software instructions encoded on a computer-readable medium, in hardware programmed or designed to perform the operations, or both. For example, aspects of the disclosure may be implemented as a system on a chip.

While no personally identifiable information is tracked by aspects of the disclosure, embodiments have been described with reference to data monitored and/or collected from users 102. In such embodiments, notice is provided to the users 102 of the collection of the data (e.g., via a dialog box or preference setting) and users 102 are given the opportunity to give or deny consent for the monitoring and/or collection. The consent may take the form of opt-in consent or opt-out consent.

### Exemplary Operating Environment

Exemplary computer readable media include flash memory drives, digital versatile discs (DVDs), compact discs (CDs), floppy disks, and tape cassettes. By way of example and not limitation, computer readable media comprise computer storage media and communication media. Computer storage media store information such as computer readable instructions, data structures, program modules or other data. Communication media typically embody computer readable instructions, data structures, program modules, or other data in a modulated data signal such as a carrier wave or other transport mechanism and include any information delivery media. Combinations of any of the above are also included within the scope of computer readable media.

Although described in connection with an exemplary computing system environment, embodiments of the invention are operational with numerous other general purpose or special purpose computing system environments or configurations. Examples of well known computing systems, environments, and/or configurations that may be suitable for use with aspects of the invention include, but are not limited to, mobile computing devices, personal computers, server computers, hand-held or laptop devices, multiprocessor systems, gaming consoles, microprocessor-based systems, set top boxes, programmable consumer electronics, mobile telephones, network PCs, minicomputers, mainframe computers, distributed computing environments that include any of the above systems or devices, and the like.

Embodiments of the invention may be described in the general context of computer-executable instructions, such as program modules, executed by one or more computers or other devices. The computer-executable instructions may be organized into one or more computer-executable components or modules. Generally, program modules include, but are not limited to, routines, programs, objects, components, and data structures that perform particular tasks or implement particular abstract data types. Aspects of the invention may be implemented with any number and organization of such components or modules. For example, aspects of the invention are not limited to the specific computer-executable instructions or the specific components or modules illustrated in the figures and described herein. Other embodiments of the invention may include different computer-executable instructions or components having more or less functionality than illustrated and described herein.

Aspects of the invention transform a general-purpose computer into a special-purpose computing device when configured to execute the instructions described herein.

The embodiments illustrated and described herein as well as embodiments not specifically described herein but within the scope of aspects of the invention constitute exemplary means for obtaining context for the first set of search results by deriving the second set of keywords therefrom and generating the second set of search results, and exemplary means for supplementing search results from a personal search index with search results from a public search index.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Having described aspects of the invention in detail, it will be apparent that modifications and variations are possible without departing from the scope of aspects of the invention as defined in the appended claims. As various changes could be made in the above constructions, products, and methods without departing from the scope of aspects of the invention, it is intended that all matter contained in the above description and shown in the accompanying drawings shall be interpreted as illustrative and not in a limiting sense.

What is claimed is:

1. A system for providing context for search results, said system comprising:
a memory area associated with a computing device, said memory area storing a first index associated with a user; and
a processor programmed to:
scan content associated with the user to derive data for inclusion in the first index stored in the memory area;
generate the first index based on the derived data;
search the first index based on a first set of keywords to generate a first set of search results;
define a second set of keywords based on the generated first set of search results;
search a second index based on the defined second set of keywords to generate a second set of search results, wherein said second index is associated with at least one other user; and
provide for display to the user at least a portion of the first set of search results and at least a portion of the second set of search results.

2. The system of claim 1, wherein the processor is programmed to scan content including one or more of the following: a social networking feed, a content feed, contact data, an electronic mail message, a text message, a web page, user browsing history, and user interaction data.

3. The system of claim 1, wherein the processor is further programmed to receive the first set of keywords from the user.

4. The system of claim 1, wherein the processor is further programmed to receive identification from the user of one or more of documents for inclusion in the first index.

5. The system of claim 1, further comprising means for obtaining context for the first set of search results by deriving the second set of keywords therefrom and generating the second set of search results.

6. The system of claim 1, further comprising means for supplementing search results from a personal search index with search results from a public search index.

7. A method comprising:
receiving a first set of search criteria from a user;
searching, by a computing device, a first index based on the received first set of search criteria to generate a first set of search results, wherein said first index is associated with the user and includes documents identified by the user;
defining a second set of search criteria based on the generated first set of search results;
searching, by a computing device, a second index based on the defined second set of search criteria to generate a second set of search results, wherein said second index is associated with at least one other user; and
providing to the user at least a portion of the first set of search results and at least a portion of the second set of search results.

8. The method of claim 7, wherein providing to the user at least a portion of the first set of search results and at least a portion of the second set of search results comprises providing, after said searching the first index and before said searching the second index, at least a portion of the first set of search results to the user.

9. The method of claim 8, further comprising monitoring interaction by the user with the provided portion of the first set of search results, and wherein defining the second set of search criteria includes defining the second set of search criteria based at least in part on the monitored interaction.

10. The method of claim 7, wherein providing to the user at least a portion of the first set of search results and at least a portion of the second set of search results comprises displaying to the user at least a portion of the first set of search results and at least a portion of the second set of search results.

11. The method of claim 7, further comprising analyzing a document of the user to derive data for inclusion in the first set of search criteria.

12. The method of claim 7, wherein defining the second set of search criteria comprises:
performing a trending analysis to the first set of search results;
defining the second set of search criteria based at least in part on data derived from the performed trending analysis.

13. The method of claim 7, wherein the first set of search results comprises a plurality of items, and wherein defining the second set of search criteria comprises identifying one or more keywords from each of the items.

14. The method of claim 13, wherein the second set of search results comprises a plurality of items each corresponding to at least one of the plurality of items in the first set of search results.

15. The method of claim 7, wherein the first set of search results comprises a plurality of items each having a date associated therewith, further comprising selecting a subset of the items based on the date, and wherein defining the second set of search criteria comprises identifying one or more keywords from the selected subset of the items.

16. The method of claim 7, wherein providing to the user at least a portion of the first set of search results and at least a portion of the second set of search results comprises providing at least a portion of the second set of search results in response to the user hovering over one or more items in the provided first set of search results.

17. One or more computer-readable media having computer-executable components, said components comprising:
a content ingestion component that when executed by at least one processor causes the at least one processor to generate a first index from data associated with a user;
a communications interface component that when executed by at least one processor causes the at least one processor to receive a first set of keywords from the user;
a private search engine component that when executed by at least one processor causes the at least one processor to search, based on the first set of keywords received by the communications interface component, the first index generated by the content ingestion component to produce a first set of search results;
a keyword generator component that when executed by at least one processor causes the at least one processor to define a second set of keywords based on the first set of search results generated by the private search engine component; and
a public search engine component that when executed by at least one processor causes the at least one processor to search a second index based on the second set of keywords defined by the keyword generator component to generate a second set of search results, wherein said second index is associated with at least one other user, wherein the communications interface component further provides to the user at least a portion of the first set of search results and at least a portion of the second set of search results.

18. The computer-readable media of claim 17, wherein at least a portion of the data associated with the user is stored by a computing device of the user, and wherein the content ingestion component is executed by a cloud computing service.

19. The computer-readable media of claim 17, wherein the first set of search results comprises a plurality of items, and wherein the keyword generator component defines the second set of keywords by identifying one or more keywords from each of the items.

20. The computer-readable media of claim 17, wherein the first set of search results comprises a plurality of items, and wherein the public search engine component generates the second set of search results by generating search results corresponding to one or more of the plurality of items.
